(19) United States
(12) Patent Application Publication
(10) Pub. No.: US 2022/0250747 A1
(43) Pub. Date: Aug. 11, 2022

(54) UNMANNED AERIAL VEHICLE, SHOOTING METHOD, AND PROGRAM

(71) Applicant: Toyo Seikan Co., Ltd., Tokyo (JP)

(72) Inventors: Atsushi KOMINAMI, Kanagawa (JP); Souji ARAKI, Kanagawa (JP)

(21) Appl. No.: 17/628,892

(22) PCT Filed: Jul. 22, 2020
(86) PCT No.: PCT/JP2020/028584

§ 371 Date: Jan. 20, 2022

(30) Foreign Application Priority Data
Jul. 23, 2019 (JP) 2019-135211

(51) Int. Cl. B64C 39/02; B64D 47/08; B64D 1/18; B05B 12/12; B05B 12/14; A01M 27/00; A01M 29/00

(52) U.S. Cl. CPC B64C 39/024; B64D 47/08; B64D 1/18; B05B 12/122; B64C 2201/12; A01M 27/00; A01M 29/00; B64C 2201/027; B05B 12/14

(57) ABSTRACT

There is provided an unmanned aerial vehicle including: a detection unit configured to detect a living body; an aiming unit configured to aim at a specific part of the living body based on a detection result of the living body; and a shooting unit configured to shoot a content, which is stored in a container, to the specific part. There is provided a shooting method for shooting a content by using an unmanned aerial vehicle, the method including: detecting a living body; aiming at a specific part of the living body based on a detection result of the living body; and shooting a content, which is stored in a container, to the specific part.

### BACKGROUND

### 1. Technical Field

The present invention relates to an unmanned aerial vehicle, a shooting method, and a program.

### 2. Related Art

In the related art, an unmanned aerial vehicle for getting rid of a harmful animal is known (for example, refer to Patent Document 1).
Patent Document 1: Japanese Patent Application Publication No. 2018-68221

### TECHNICAL PROBLEM

With the method of the related art, it is not possible to aim at a specific part of a harmful animal recognized by an image.

### General Disclosure

A first aspect of the present invention provides an unmanned aerial vehicle including: a detection unit configured to detect a living body; an aiming unit configured to aim at a specific part of the living body based on a detection result of the living body; and a shooting unit configured to shoot a content, which is stored in a container, to the specific part.

The unmanned aerial vehicle may include a storage unit configured to store data relating to the living body and the content. The unmanned aerial vehicle may include a determination unit configured to determine whether it is possible to shoot the content based on the stored data.

The unmanned aerial vehicle may include an impact control unit configured to match an expected impact location of the shooting unit to the specific part.

The unmanned aerial vehicle may include a direction change device that is connected to the shooting unit. The impact control unit may be configured to control the direction change device to match the expected impact location of the shooting unit to the specific part.

The unmanned aerial vehicle may include a nozzle that is provided in the shooting unit and that is configured to shoot the content. The unmanned aerial vehicle may include a direction change device that is connected to the nozzle. The impact control unit may be configured to control the direction change device to match the expected impact location of the shooting unit to the specific part.

The unmanned aerial vehicle may include a first camera for detecting the living body. The unmanned aerial vehicle may include a second camera for operating the unmanned aerial vehicle.

The unmanned aerial vehicle may include a plurality of containers in which different contents are respectively stored. The unmanned aerial vehicle may include a selection unit configured to select the content to be used according to the detection result of the living body, and select the container for shooting the content.

The selection unit may be configured to switch the content to be shot to the living body according to a reaction of the living body to the shot content.

The content may have a repelling ability against the living body.

The content may have an attracting ability to the living body.

The selection unit may be configured to switch the content to enhance a performance, in switching the content to be shot to the living body.

The content may be a marking material for marking the living body.

The shooting unit may be connected to at least one of an aerosol can or a pressurized tank.

A second aspect of the present invention provides a shooting method for shooting a content by using an unmanned aerial vehicle, the method including: detecting a living body; aiming at a specific part of the living body based on a detection result of the living body; and shooting a content, which is stored in a container, to the specific part.

The shooting method may include storing data relating to the living body and the content. The shooting method may include determining whether it is possible to shoot the content based on the stored data.

The shooting method may include matching an expected impact location of the content to the specific part.

The shooting method may include selecting the content in accordance with the detection result of the living body, from among a plurality of contents.

The selecting may include switching the content to be shot to the living body according to a reaction of the living body to the shot content.

The selecting may include switching the content to enhance a performance, in switching the content to be shot to the living body.

A third aspect of the present invention provides a program for causing a computer to execute the shooting method according to the second aspect of the present invention.

The summary clause does not necessarily describe all necessary features of the embodiments of the present invention. The present invention may also be a sub-combination of the features described above.

### BRIEF DESCRIPTION OF THE DRAWINGS

FIG. 1A shows an example of a front view of an unmanned aerial vehicle 100.

FIG. 1B shows an example of a left side view of the unmanned aerial vehicle 100 according to FIG. 1A.

FIG. 2A is another example showing the front view of the unmanned aerial vehicle 100.

FIG. 2B shows a left side view of the unmanned aerial vehicle 100 according to FIG. 2A.

FIG. 3 shows an example of a configuration of a container holding unit 40.

FIG. 4 shows an example of a steering system 300 of the unmanned aerial vehicle 100.

FIG. 5A shows an example of a functional block of the unmanned aerial vehicle 100.

FIG. 5B is a flowchart showing a shooting method for shooting a content by using the unmanned aerial vehicle 100.

FIG. 6A is an example of a display screen 214 of a display unit 210.

FIG. 6B is an example of a display screen 216 of the display unit 210.

FIG. 7A shows an example of a controller 230 for a steering control.

FIG. 7B shows an example of a controller 240 for a shooting control.

FIG. 7C shows an example of the controller 240 for the shooting control.

FIG. 7D shows an example of a controller 250 for the steering control and the shooting control.

FIG. 8A shows an example of a procedure of shooting the content to a living body 600.

FIG. 8B shows an example of a procedure of shooting the content to the living body 600.

FIG. 8C shows an example of a procedure of shooting the content to the living body 600.

FIG. 9A is an example of a method of utilizing a marking material 104.

FIG. 9B is an example of a method of utilizing the marking material 104.

FIG. 10A shows an example of the front view of the unmanned aerial vehicle 100.

FIG. 10B shows an example of a left side view of the unmanned aerial vehicle 100 according to FIG. 10A.

FIG. 11 shows an example of a shooting device 500 in the unmanned aerial vehicle 100.

FIG. 12 shows an example of a computer 2200 in which a plurality of aspects of the present invention may be embodied entirely or partially.

### DESCRIPTION OF EXEMPLARY EMBODIMENTS

Hereinafter, the invention will be described through embodiments of the invention, but the following embodiments do not limit the invention according to claims. Further, not all of the combinations of features described in the embodiments are essential for means to solve the problem in the invention.

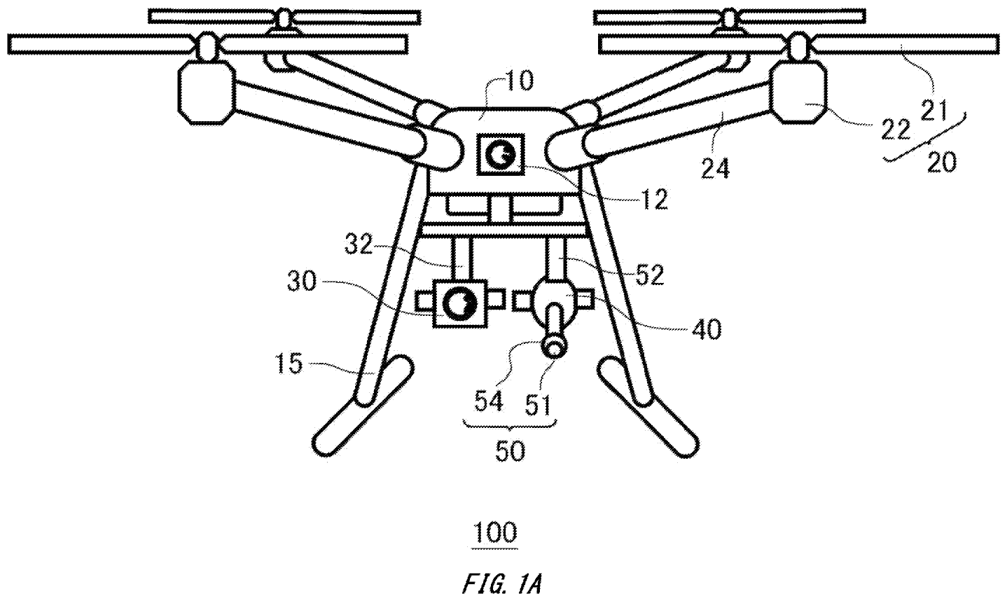

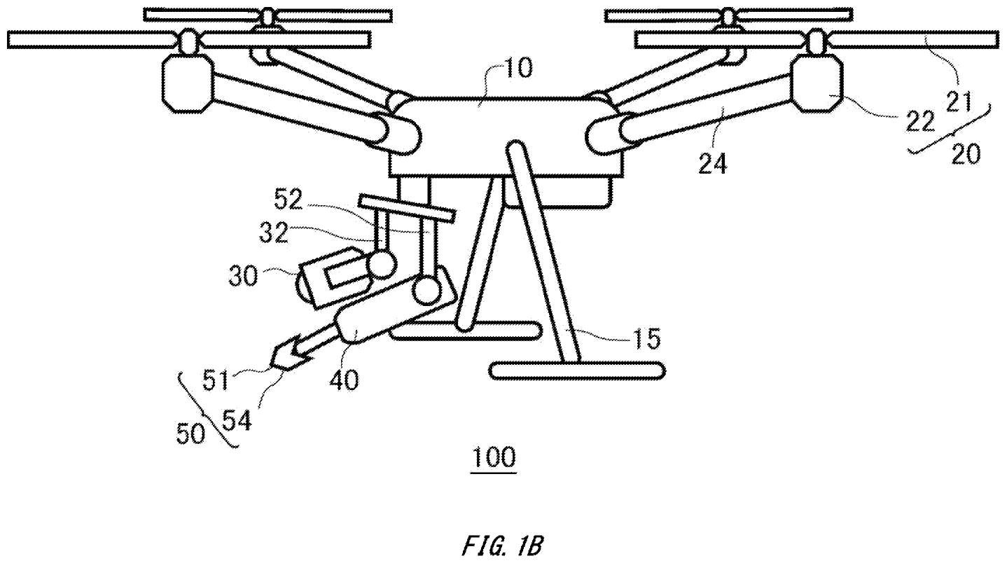

FIG. 1A shows an example of a front view of an unmanned aerial vehicle 100. FIG. 1B shows an example of a left side view of the unmanned aerial vehicle 100 according to FIG. 1A.

The unmanned aerial vehicle 100 is a flying object that flies in the air. The unmanned aerial vehicle 100 of the present example includes a main body unit 10, a propulsion unit 20, a movable camera 30, a container holding unit 40, and a shooting unit 50. Note that in the present specification, in the main body unit 10, a surface on which a fixed camera 12 is provided is referred to as a front surface of the unmanned aerial vehicle 100; however, a flight direction is not limited to a direction of the front surface.

The main body unit 10 stores various control circuits, a power source, and the like of the unmanned aerial vehicle 100. In addition, the main body unit 10 may function as a structure body for connecting components to each other in the unmanned aerial vehicle 100. The main body unit 10 of the present example is connected to the propulsion unit 20. The main body unit 10 of the present example includes the fixed camera 12.

The fixed camera 12 is provided on a side surface of the main body unit 10. The fixed camera 12 captures a video from the front surface of the unmanned aerial vehicle 100. In an example, the video captured by the fixed camera 12 is transmitted to a user. The user of the unmanned aerial vehicle 100 may operate the unmanned aerial vehicle 100 based on the video captured by the fixed camera 12.

The propulsion unit 20 propels the unmanned aerial vehicle 100. The propulsion unit 20 has a rotor blade 21 and a rotation drive unit 22. The unmanned aerial vehicle 100 of the present example includes four propulsion units 20. The propulsion unit 20 is attached to the main body unit 10 via an arm unit 24.

The propulsion unit 20 obtains a propulsive force by rotating the rotor blade 21. Four rotor blades 21 are provided around the main body unit 10; however, a method of arranging the rotor blades 21 is not limited to the present example. The rotor blade 21 is provided at a tip of the arm unit 24 via the rotation drive unit 22.

The rotation drive unit 22 has a power source such as a motor and drives the rotor blade 21. The rotation drive unit 22 may have a brake mechanism for the rotor blade 21. The rotor blade 21 and the rotation drive unit 22 may be directly attached to the main body unit 10 by omitting the arm unit 24.

The arm unit 24 is provided to extend radially from the main body unit 10. The unmanned aerial vehicle 100 of the present example includes four arm units 24 that are provided corresponding to the four propulsion units 20. The arm unit 24 may be fixed or movable. Another component such as a camera may be fixed to the arm unit 24.

The movable camera 30 captures a video around the unmanned aerial vehicle 100. The movable camera 30 of the present example is provided below the main body unit 10. In an example, below refers to a side opposite to a side on which the rotor blade 21 is provided, across the main body unit 10. The movable camera 30 captures a video in a region different from that for the fixed camera 12 provided in the main body unit 10. For example, in order to control shooting from the shooting unit 50, the movable camera 30 acquires a video in a region narrower than that for the fixed camera 12. In addition, the movable camera 30 may capture a video in a shooting direction of the shooting unit 50 when the fixed camera 12 captures a video in an advance direction.

The unmanned aerial vehicle 100 of the present example includes the fixed camera 12 for steering and the movable camera 30 for a shooting control, and thus an operation by the user is easy. That is, it is not necessary to switch between an operation screen for steering and an operation screen for the shooting control, and thus it is possible to prevent confusion of the user. In addition, it is possible to easily grasp a situation around the unmanned aerial vehicle 100 while carrying out the shooting control.

A connection unit 32 connects the main body unit 10 and the movable camera 30. The connection unit 32 may be fixed or movable. The connection unit 32 may be a gimbal for controlling a position of the movable camera 30 in three axis directions. The connection unit 32 may control an orientation of the movable camera 30 according to the shooting direction of the shooting unit 50.

The container holding unit 40 holds a container 150 that is filled with a content to be shot and that will be described below. The container holding unit 40 is connected to the main body unit 10 via a direction change device 52. The container holding unit 40 may be connected to a member, such as the arm unit 24 or a leg unit 15, other than the main body unit 10. In an example, the container holding unit 40 is a cylindrical sleeve that houses the container 150.

A material of the container holding unit 40 is not particularly limited as long as the material can hold a shape of a housing unit that houses the container 150. For example, the material of the container holding unit 40 includes metal such as aluminum, plastic, or a lightweight material having a high strength such as carbon fiber. In addition, the material of the container holding unit 40 is not limited to a hard material, and may include a soft material, for example, a rubber material such as silicone rubber or urethane foam. Note that the container holding unit 40 may include a heating mechanism for heating the container 150 or maintaining a temperature of the container 150.

The direction change device 52 connects the main body unit 10 and the container holding unit 40. The direction change device 52 may be a gimbal for controlling a position of the container holding unit 40 in the three axis directions. In an example, the direction change device 52 adjusts the shooting direction of the shooting unit 50 by moving the position of the container holding unit 40. Note that by unifying a standard of the direction change device 52, it is possible to make a replacement with any container holding unit 40 that matches the container 150. This makes it possible to handle containers 150 of different sizes or types.

The shooting unit 50 is connected to the container 150, and shoots the content. The shooting unit 50 has a shooting port 51 and a nozzle 54. The shooting unit 50 shoots, from the shooting port 51, the content flowing into the nozzle 54. An orientation of the shooting port 51 may be freely controlled according to a desired direction for shooting.

The content may be any of a liquid, a gas, or a solid. The content may be in a powdery, granular, or gel shape state, or the like. In an example, the content has a repelling ability against a living body and is used to drive away the living body. The content may have an attracting ability to the living body, to be used to attract the living body. The content may be a marking material for marking the living body. The content may include irritants such as capsaicin, lemon juice, salt water, wasabi extract (allyl isothiocyanate), ammonia, thiol, mint, allicin, allyl sulfide, ginger (gingerol), alcohol, may include hot water or cold water, or may include tear gas. The living body may be a monkey, a boar, a bear, a deer, a bird, a reptile (a lizard, a snake, a crocodile), an amphibian, or the like; however, the living body is not limited to these. A specific method of using the content will be described below.

The container 150 is a container in which the content is filled. In an example, the container 150 is an aerosol container of which an inside is filled with the content, and from which the content is shot. The aerosol container sprays the content by gas pressure of liquefied gas or compressed gas with which the inside of the aerosol container is filled. The container 150 of the present example is a metal aerosol can, but may be a plastic container having a pressure resistance. The container 150 is mounted in a state of being housed in the container holding unit 40.

Note that as a propellant, liquefied gas of hydrocarbon (liquefied petroleum gas) (LPG), dimethyl ether (DME), fluorinated hydrocarbon (HFO-1234ze), or the like, and compressed gas of carbon dioxide (CO₂), nitrogen (N₂), nitrous oxide (N₂O), or the like, may be used.

The leg unit 15 is connected to the main body unit 10 and holds a posture of the unmanned aerial vehicle 100 at a time of landing. The leg unit 15 is an example of a posture holding unit. The posture holding unit holds the posture of the unmanned aerial vehicle 100 in a state in which the rotor blade 21 is stopped. The unmanned aerial vehicle 100 of the present example has two leg units 15. By a plurality of leg units 15 respectively extending to different lengths, it is possible to stably hold the posture of the unmanned aerial vehicle 100 even on the sloped ground or an uneven surface. In addition, in the unmanned aerial vehicle 100, a length of the leg unit 15 may be sufficiently extended so as not to damage a plant in a field or the like. The movable camera 30 or the container holding unit 40 may be attached to the leg unit 15.

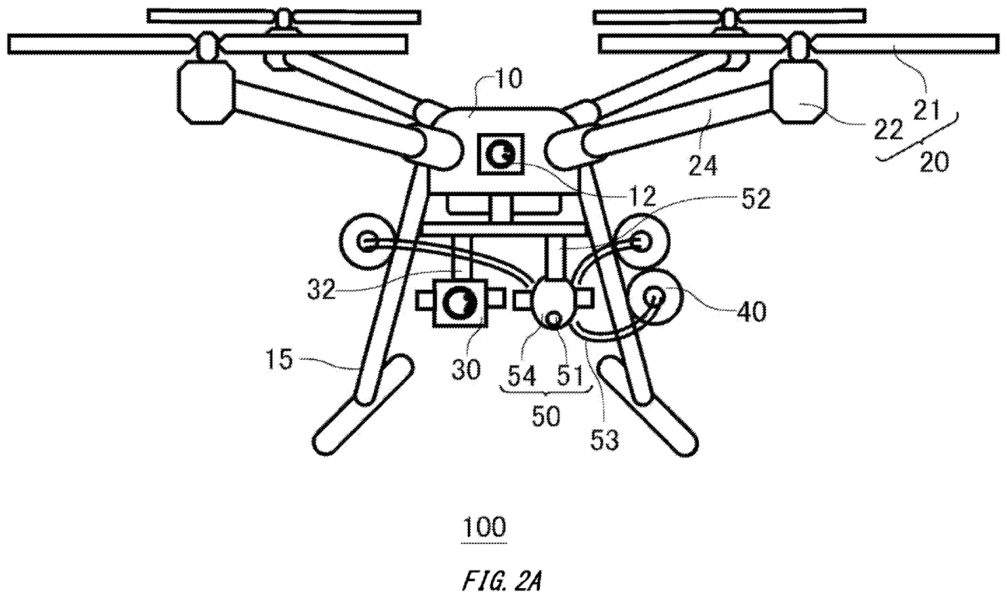

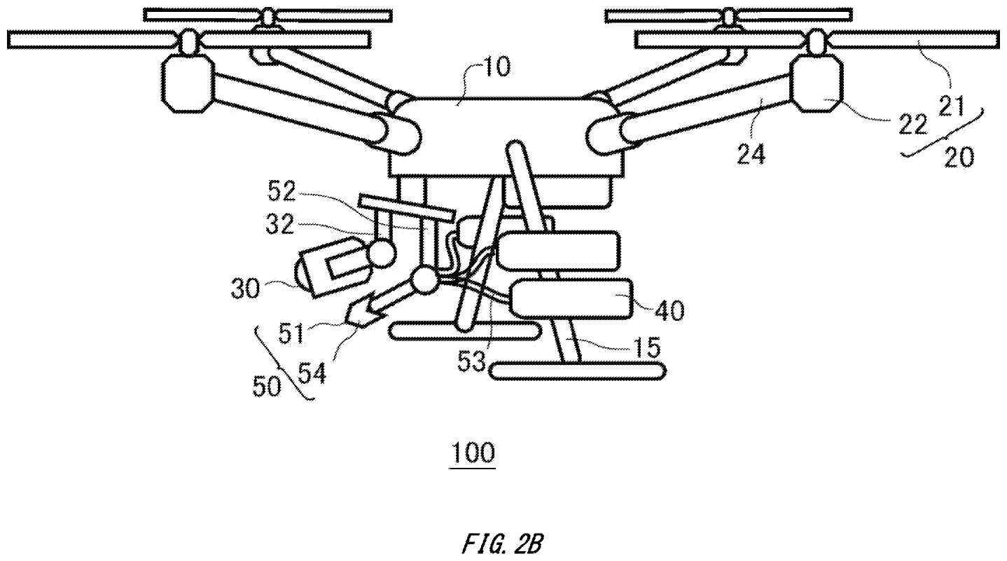

FIG. 2A is another example showing the front view of the unmanned aerial vehicle 100. FIG. 2B shows a left side view of the unmanned aerial vehicle 100 according to FIG. 2A. The unmanned aerial vehicle 100 of the present example is different from Examples of FIG. 1A and FIG. 1B in that the unmanned aerial vehicle 100 of the present example includes a plurality of container holding units 40. In the present example, the difference from Examples of FIG. 1A and FIG. 1B will be particularly described.

Each of the plurality of container holding units 40 includes the container 150. A plurality of containers 150 may store the same content, or may store different contents. The unmanned aerial vehicle 100 of the present example includes three container holding units 40; however, the number of the container holding unit 40 included in the unmanned aerial vehicle 100 is not limited to this. The plurality of container holding units 40 are attached to the leg unit 15. The plurality of container holding units 40 may be attached to the same leg unit 15, or may be respectively attached to the different leg units 15. In the present example, two container holding units 40 are provided on the same leg unit 15, and the remaining one container holding unit 40 is provided on the other leg unit 15.

The shooting unit 50 is commonly provided in the plurality of containers 150. The shooting unit 50 may be provided for each of the plurality of containers 150. In the present example, three shooting units 50 may be provided for the three containers 150. The shooting unit 50 of the present example is connected to the main body unit 10 by the direction change device 52. A position of the shooting unit 50 may be adjusted by the direction change device 52. The shooting unit 50 of the present example is connected to the container 150 by an extension unit 53 that is provided to extend from the container 150.

The direction change device 52 is connected to the shooting unit 50. The direction change device 52 is also connected to the nozzle 54, and changes a direction of the nozzle 54 by controlling a posture of the shooting unit 50. By the direction change device 52 being connected with the shooting unit 50, it becomes easy to remotely operate the shooting direction.

The extension unit 53 is provided to extend from the container 150 of the container holding unit 40 to the shooting unit 50. This makes it possible for the extension unit 53 to arrange the shooting unit 50 at any location which is away from the container holding unit 40. Therefore, a degree of freedom in a layout of the unmanned aerial vehicle 100 is enhanced. The number of the extension units 53 that are provided may be in accordance with the number of the container holding units 40. One extension unit 53 of the present example is provided for each of the three container holding units 40. From among the plurality of containers 150, the shooting unit 50 may select any container 150 to shoot the content in time division, or may shoot the contents from the plurality of containers 150 at the same time.

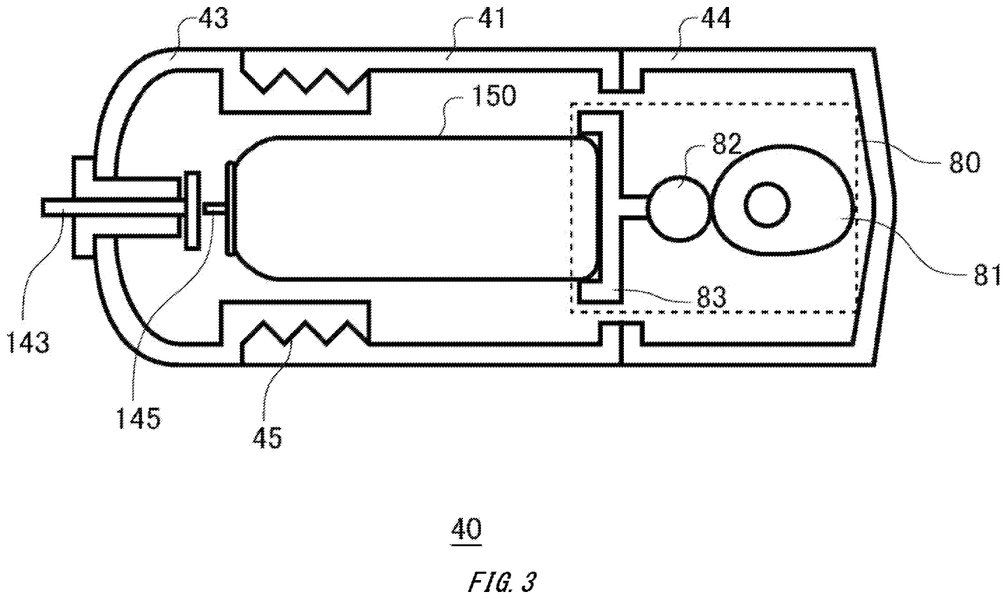

FIG. 3 shows an example of a configuration of a container holding unit 40. FIG. 3 shows a cross-sectional view of the container holding unit 40. The container holding unit 40 holds the container 150. The container holding unit 40 of the present example includes a main body 41, a first end cover unit 43, and a second end cover unit 44. In addition, the container holding unit 40 includes a shooting drive unit 80 for controlling the shooting from the container 150.

The main body 41 holds the container 150. The main body 41 has a cylindrical shape with a diameter larger than that of the container 150. The main body 41 of the present example is interposed between the first end cover unit 43 and the second end cover unit 44.

The first end cover unit 43 covers one end portion of the main body 41. The first end cover unit 43 of the present example covers an end portion of the container 150 on a spraying side. The first end cover unit 43 is screwed and fixed to the main body 41 via a screw unit 45 in an attachable and detachable manner. The first end cover unit 43 of the present example has a cover main body with a dome shape. A diameter of the first end cover unit 43 is reduced to gradually decrease toward a tip in consideration of aerodynamic characteristics. The first end cover unit 43 has a curved surface which has a conical or dome shape and a rounded tip. By forming the shape with good aerodynamic characteristics in this way, it is possible to reduce an influence of a crosswind and to stabilize a flight.

In the main body 41, the second end cover unit 44 covers the other end portion which is different from the end portion covered by the first end cover unit 43. The second end cover unit 44 of the present example covers the end portion of the container 150 on a side opposite to the spraying side. The second end cover unit 44 is configured to be integrated with the main body 41. In addition, the second end cover unit 44 may be provided to be removable from the main body 41.

The shooting drive unit 80 causes the content to be shot from the container 150. The shooting drive unit 80 is housed in the second end cover unit 44 located on a bottom side of the container 150. The second end cover unit 44 functions as a housing of the shooting drive unit 80. The shooting drive unit 80 includes a cam 81, a cam follower 82, and a movable plate 83. The shooting drive unit 80 is provided in the container holding unit 40, and thus it is not necessary to replace the shooting drive unit 80 when the container 150 is replaced.

The cam 81 is driven to rotate by a drive source. In an example, a motor is used as the drive source. The cam 81 has a structure in which distances from the rotation center to the outer circumference vary. Note that in an illustrated example, a shape of the cam 81 is exaggerated. The cam 81 is in contact with the cam follower 82 on the outer circumference.

The cam follower 82 is provided between the cam 81 and the movable plate 83. The cam follower 82 is connected to the cam 81 and the movable plate 83, and transmits a rotary motion of the cam 81 to the movable plate 83 as a linear motion.

The movable plate 83 is provided to be in contact with a bottom surface of the container 150, and controls an opening and closing of a valve of the container 150. The movable plate 83 is moved back and forth by the cam follower 82. For example, when a distance between the rotation center of the cam 81 and a contact region of the cam 81 with which the cam follower 82 abuts is short, the movable plate 83 retreats with respect to the container 150, and the valve of the container 150 is closed. On the other hand, when a distance between the rotation center of the cam 81 and a contact region of the cam 81 with which the cam follower 82 abuts is long, the movable plate 83 advances with respect to the container 150, and the valve of the container 150 opens.

Note that the shooting drive unit 80 has a configuration in which the rotary motion of the motor is transformed into the linear motion by a cam mechanism; however, the shooting drive unit 80 is not limited to the cam mechanism. For example, a mechanism of the shooting drive unit 80 only needs to be a mechanism such as a screw feed mechanism or a rack and pinion that transforms the rotary motion of the motor into the linear motion. In addition, as the drive source, a linear motor for a linear drive, an electromagnetic solenoid, or the like may be included instead of the rotary motor.

A stem 145 is provided in the container 150. By the stem 145 being pressed by an actuator 143, the content is shot from the container 150. The actuator 143 has a flow path in accordance with the shooting direction and a shooting mode. In an example, the actuator 143 nebulizes and shoots the content.

Note that in the present example, the container 150 is directly mounted on the container holding unit 40; however, the container 150 may be housed by a housing member and the housing member may be mounted on the container holding unit 40. The housing member protects the container 150 from an impact, and thus safety at a time of an accident is enhanced.

The container 150 of the present example is the aerosol container, and thus even when the container 150 is empty, it is possible to easily make a replacement by simply mounting the new container 150. In addition, the content is less likely to adhere to a human body and is highly safe at the time of the replacement.

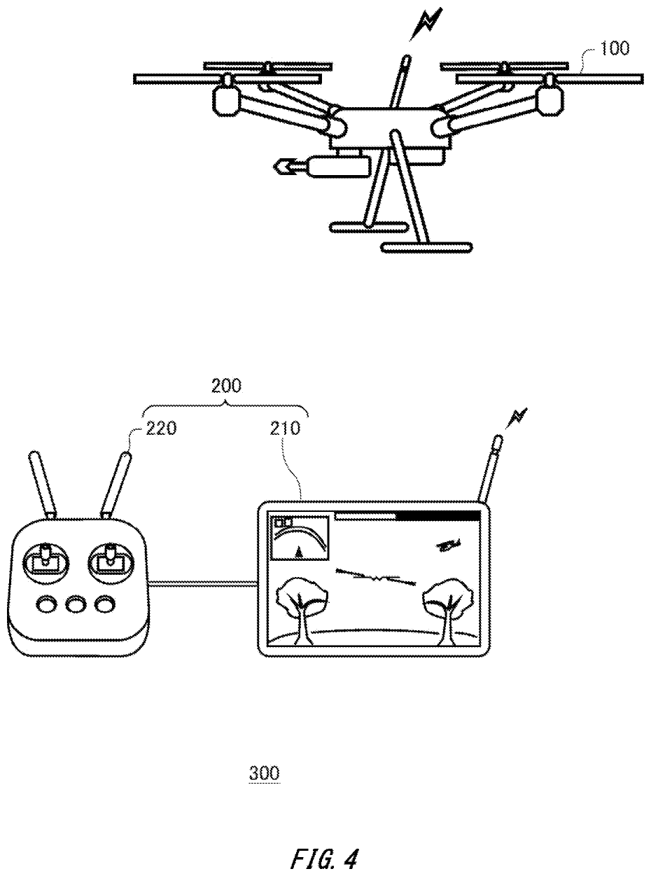

FIG. 4 shows an example of a steering system 300 of the unmanned aerial vehicle 100. The steering system 300 of the present example includes the unmanned aerial vehicle 100 and a terminal device 200. The terminal device 200 includes a display unit 210 and a controller 220.

The display unit 210 displays the video captured by the camera mounted on the unmanned aerial vehicle 100. The display unit 210 may display the video captured by each of the fixed camera 12 and the movable camera 30. For example, the display unit 210 displays the videos captured by the fixed camera 12 and the movable camera 30 on a divided screen. The display unit 210 may directly communicate with the unmanned aerial vehicle 100, or may indirectly communicate with the unmanned aerial vehicle 100 via the controller 220. The display unit 210 may be connected to an external server.

The controller 220 is operated by the user to steer the unmanned aerial vehicle 100. The controller 220 may give an instruction of shooting the content, which is performed by the shooting unit 50, in addition to the flight of the unmanned aerial vehicle 100. The controller 220 may be connected to the display unit 210 in a wired or wireless manner. A plurality of controllers 220 may be provided to be used differently for the steering of the unmanned aerial vehicle 100, and for the shooting control of the shooting unit 50.

Note that the user of the present example manually steers the unmanned aerial vehicle 100 by using the terminal device 200. Note that the user may steer the unmanned aerial vehicle 100 automatically by a program rather than manually. In addition, the user may directly see and steer the unmanned aerial vehicle 100 without using the screen displayed on the display unit 210. In addition, while the steering of the unmanned aerial vehicle 100 is automatically controlled, the shooting of the shooting unit 50 may be manually operated.

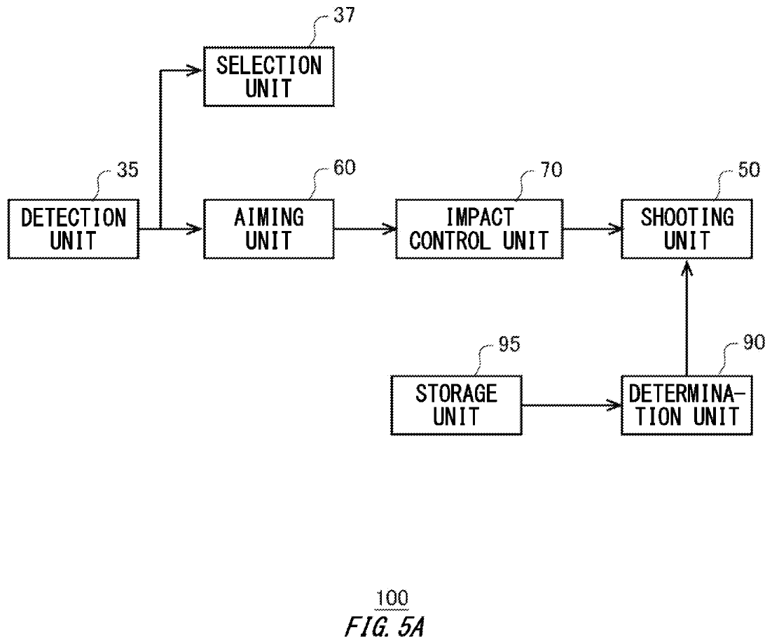

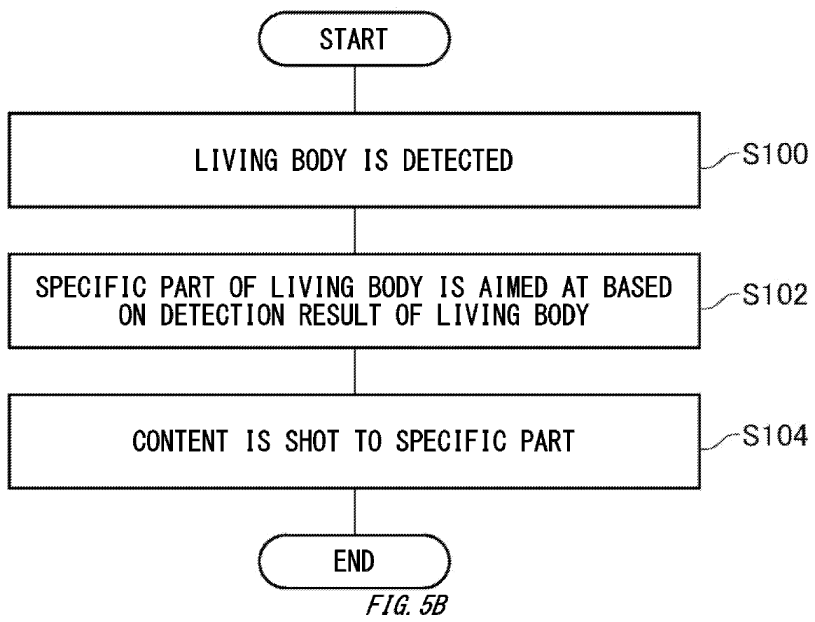

FIG. 5A shows an example of a functional block of the unmanned aerial vehicle 100. The unmanned aerial vehicle 100 includes a detection unit 35, a selection unit 37, the shooting unit 50, an aiming unit 60, an impact control unit 70, a determination unit 90, and a storage unit 95.

The detection unit 35 detects the living body. The living body will be described below. In an example, the detection unit 35 is the fixed camera 12 or the movable camera 30. The movable camera 30 is an example of a first camera for detecting the living body. The fixed camera 12 is an example of a second camera for operating the unmanned aerial vehicle 100. In addition, the first camera for detecting the living body may be an infrared camera. In addition, the living body may be detected by processing captured image data of the camera, with a determination program by machine learning.

The selection unit 37 selects the content to be used according to a detection result of the living body, and selects the container 150 for shooting the content. The selection unit 37 may switch the content to be shot to the living body according to a reaction of the living body to the shot content. The selection unit 37 may switch the content to enhance a performance, in switching the content to be shot to the living body. To enhance the performance refers to, as an example, to select a content with a stronger concentration, an effect, an irritating nature, or the like of the content.

The aiming unit 60 aims at a specific part of the living body based on the detection result of the living body. The aiming unit 60 acquires an image of the living body detected by the detection unit 35. The aiming unit 60 recognizes the image of the living body and aims at a predetermined specific part from among parts of the living body. For example, in a moving living body, a head part is specified by sensing a peripheral part of the living body in an advance direction.

The specific part of the living body refers to a part of the living body that is a target to which the content is shot and on which the content is caused to impact. To impact means that the content, which is shot from the shooting unit 50, reaches the specific part. For example, the specific part of the living body is a nose, eyes, legs, a trunk, buttocks, or the like. The specific part of the living body may be selected according to a shooting situation, a habit of the living body, or the content. In an example, by shooting toward the buttocks of the living body, the living body is very likely to run away in a direction of the head part, and thus the unmanned aerial vehicle 100 can have directionality in a direction of moving away from the living body, and can safely drive away the living body. In addition, the unmanned aerial vehicle 100 can aim at a vital point of the living body and shoot, thereby realizing more effective shooting.

The impact control unit 70 matches an expected impact location of the shooting unit 50 to the specific part of the living body. For example, the impact control unit 70 controls the direction change device 52 to match the expected impact location of the shooting unit 50 to the specific part. The impact control unit 70 may control the posture of the shooting unit 50 according to a property of the content, an influence of a wind, or the like.

The storage unit 95 stores data relating to the living body and the content. For example, the storage unit 95 stores a feature of the living body that is a shooting target. The storage unit 95 may store information on permission to shoot, the information indicating a region regarding whether it is possible to shoot the content in the region.

The determination unit 90 determines whether it is possible to shoot the content based on the data stored in the storage unit 95. For example, the determination unit 90 determines whether to shoot based on whether the specified living body is the shooting target, whether the specific part of the living body is sufficiently exposed, or the like. Based on location information of the unmanned aerial vehicle 100 which is acquired by a GPS, the determination unit 90 may determine whether to shoot based on whether it is possible to shoot the content in the region.

The shooting unit 50 shoots the content to the specific part. The shooting unit 50 of the present example can take aim at the specific part of the living body, and shoot at an appropriate timing. Thereby, useless shooting is suppressed. Note that a shooting mechanism of the unmanned aerial vehicle 100 may be any mechanism that is capable of shooting the content to the specific part, may be a shooting mechanism that uses the aerosol can, or a shooting mechanism by a tank pressurization method described below.

FIG. 5B is a flowchart showing a shooting method for shooting a content by using the unmanned aerial vehicle 100. The shooting method of the present example is an example, and the present invention is not limited to this.

In step S100, the living body is detected. Step S100 may have a step of luring the living body by a content having an attracting ability, and detecting the living body. For example, the living body is lured by spraying foods.

In step S102, the specific part of the living body is aimed at based on the detection result of the living body. The specific part of the living body may be determined based on the data stored in advance.

In step S104, the content is shot to the specific part. A step of shooting a different content may be further included according to the reaction of the living body after the content is shot.

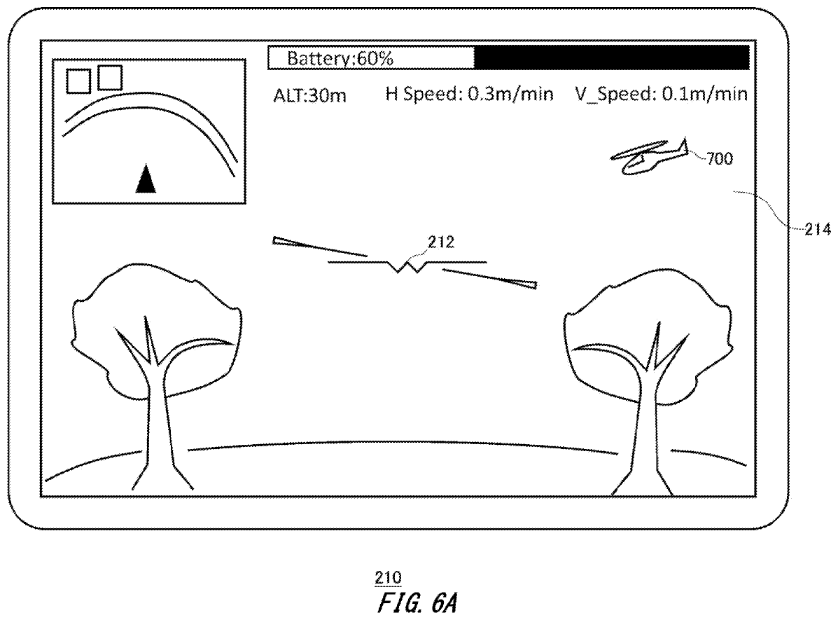

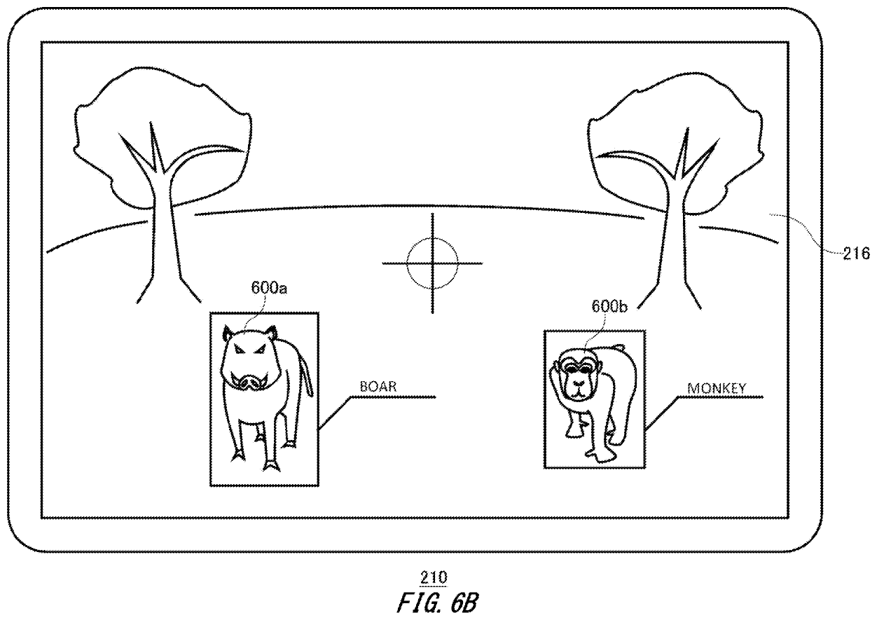

FIG. 6A is an example of a display screen 214 of a display unit 210. The display screen 214 is a steering screen that displays the video around the unmanned aerial vehicle 100 captured by the fixed camera 12. The display screen 214 displays an altitude, a horizontal speed, a vertical speed, and a battery level of the unmanned aerial vehicle 100. A center location 212 indicates the center of the display screen 214 and corresponds to a center location of the fixed camera 12.

The display screen 214 displays the advance direction of the unmanned aerial vehicle 100 shown by the fixed camera 12. The display screen 214 makes it possible to grasp the situation around the unmanned aerial vehicle 100. On the display screen 214 of the present example, a flying object 700 that is a helicopter is projected, and a steering person can pay attention to an approaching object around the helicopter. The unmanned aerial vehicle 100 may automatically control a flight path based on the video projected on the display unit 210, or may be manually steered by the user.

FIG. 6B is an example of a display screen 216 of the display unit 210. The display screen 216 is a shooting control screen obtained by using the video acquired by the movable camera 30. The display screen 216 displays the video in the shooting direction of the shooting unit 50. The display screen 216 of the present example displays a living body 600 that is the shooting target. The movable camera 30 of the present example recognizes a living body 600a as a boar, and a living body 600b as a monkey.

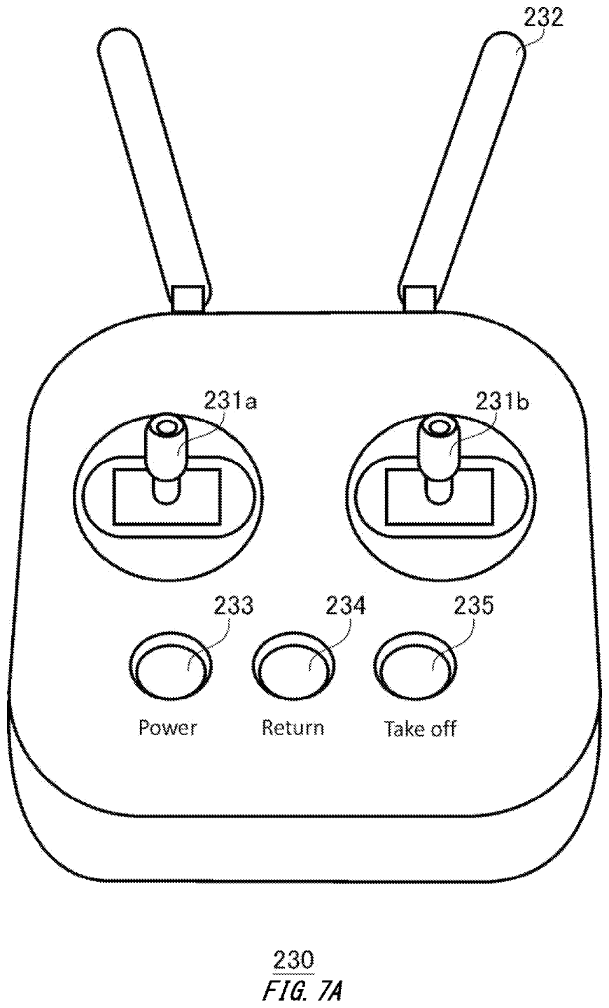

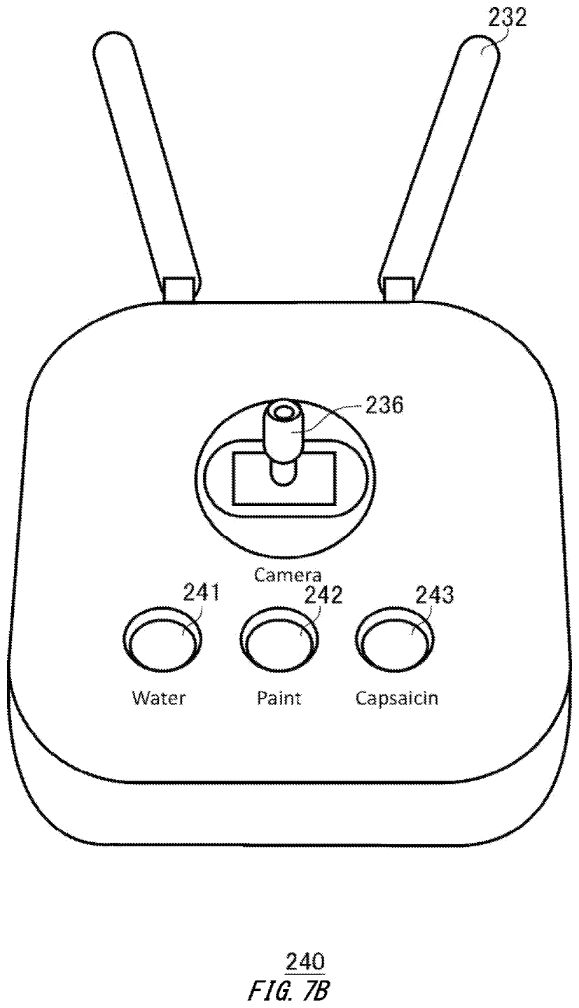

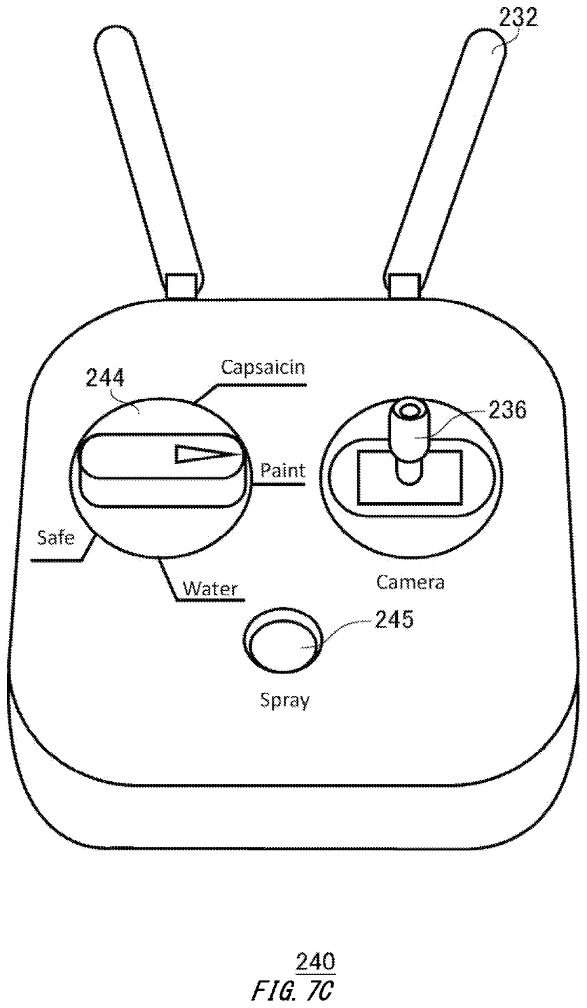

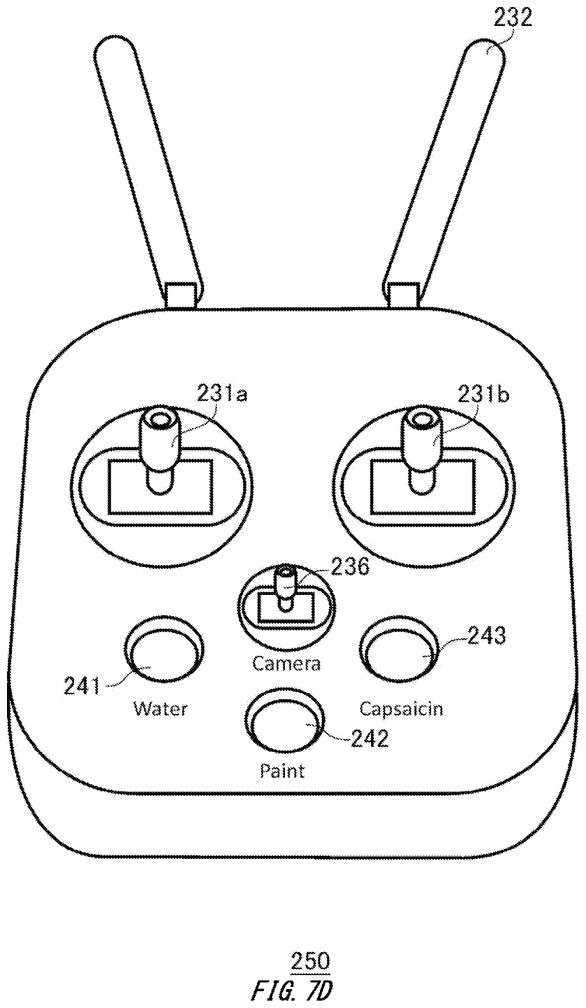

FIG. 7A shows an example of a controller 230 for a steering control. The flight of the unmanned aerial vehicle 100 is remotely operated by the controller 230. The controller 230 includes a control stick 231, an antenna 232, a power button 233, a return button 234, and a takeoff button 235.

The control stick 231 controls the flight of the unmanned aerial vehicle 100. The controller 230 of the present example has two control sticks, which are a control stick 231a and a control stick 231b. For example, the control stick 231 is used to control a throttle, an elevator, a ladder, and an aileron of the unmanned aerial vehicle 100.

The antenna 232 is used to communicate with the unmanned aerial vehicle 100. The controller 230 of the present example includes two antennas 232. The antenna 232 may be used to communicate with the display unit 210 or an external computer.

The power button 233 is a button for switching between on and off of the power source of the unmanned aerial vehicle 100. The return button 234 is a button for returning the unmanned aerial vehicle 100 to a predetermined home location. The takeoff button 235 is a button for starting a takeoff of the unmanned aerial vehicle 100. These buttons are examples, and a function may be added or omitted.

FIG. 7B shows an example of a controller 240 for a shooting control. The controller 240 of the present example is a controller for the shooting control, and the steering of the unmanned aerial vehicle 100 may be performed by another controller. The controller 230 and the controller 240 may be separately used by two persons. In addition, while the steering of the unmanned aerial vehicle 100 is performed automatically, the shooting control may be performed manually. On the contrary, while the steering of the unmanned aerial vehicle 100 is performed manually, the shooting control may be performed automatically.

The controller 240 includes the antenna 232, a camera operation stick 236, a first shooting button 241, a second shooting button 242, and a third shooting button 243. The number and functions of the shooting buttons are not limited to the present example.

The camera operation stick 236 controls a video capturing location of the detection unit 35 mounted on the unmanned aerial vehicle 100. For example, the camera operation stick 236 is used to control the posture of the movable camera 30 for taking aim at the shooting target.

Different contents are respectively assigned to the first shooting button 241 to the third shooting button 243. By pressing the first shooting button 241, a harmless content such as water is shot. By pressing the second shooting button 242, a paint material for marking is shot. By pressing the third shooting button 243, an irritant such as capsaicin is shot.

FIG. 7C shows an example of the controller 240 for the shooting control. The controller 240 includes the antenna 232, the camera operation stick 236, a selection dial 244, and a shooting button 245. The controller 240 of the present example is different from that of FIG. 7B in that the content is selected by the selection dial 244. In the present example, the difference from FIG. 7B will be particularly described.

The selection dial 244 selects the content to be shot from the shooting unit 50. The selection dial 244 of the present example selects water, paint, or capsaicin, as the content. In addition, the selection dial 244 can select a safe state. In the safe state, the shooting from the shooting unit 50 is prohibited to avoid accidental shooting of the content. The prohibition of the shooting may be a soft lock in which the shooting is prohibited by an electronic control, or may be a hard lock in which the shooting is prohibited by a mechanical control.

The shooting button 245 is a button for the shooting control. By pressing the shooting button 245, the content selected by the selection dial 244 is shot. When the shooting button 245 is released, the shooting of the content is stopped.

FIG. 7D shows an example of a controller 220 for the steering control and the shooting control. The controller 250 of the present example includes the control stick 231, the antenna 232, the camera operation stick 236, the first shooting button 241, the second shooting button 242, and the third shooting button 243. The controller 250 of the present example also serves as a controller for both of the steering control and the shooting control, and can be steered by one person.

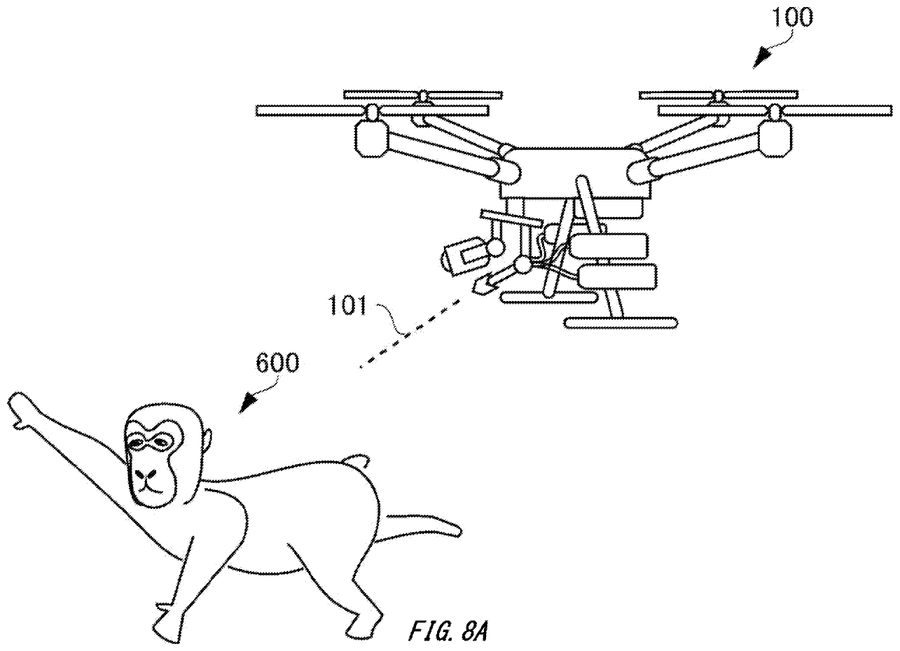

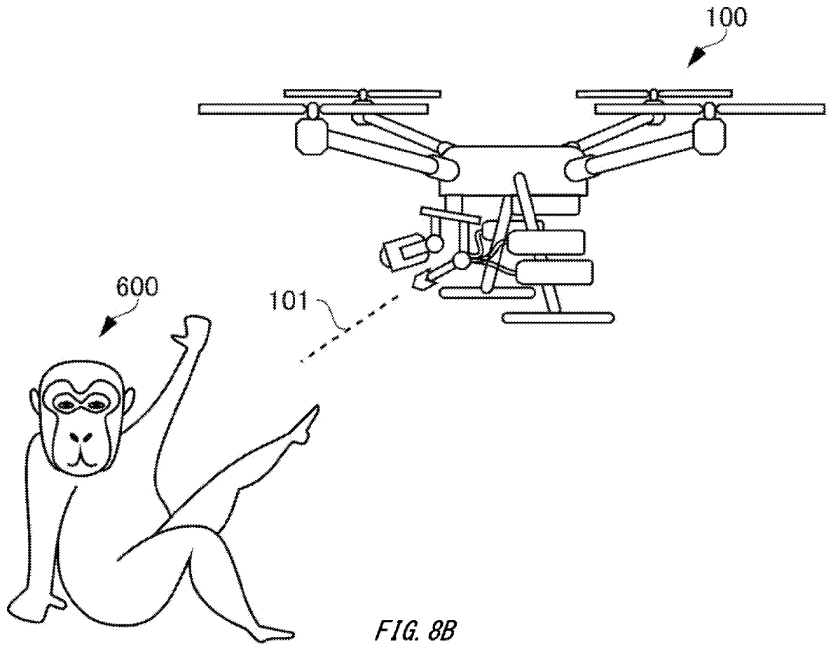

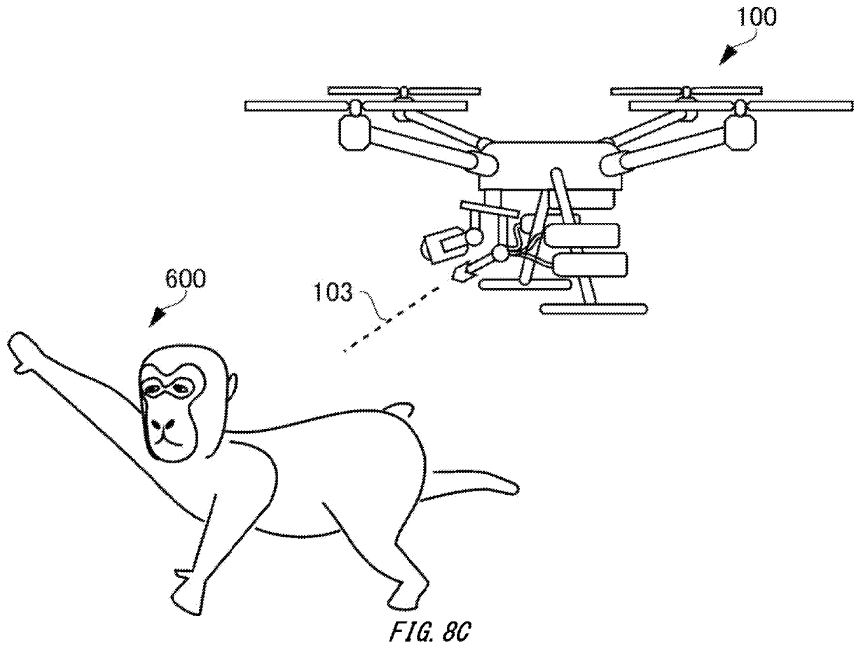

FIG. 8A shows an example of a procedure of shooting the content to a living body 600. The unmanned aerial vehicle 100 of the present example shoots a content 101 to the living body 600. The unmanned aerial vehicle 100 shoots the water, as the content 101, to the living body 600. In this way, it is possible for even the harmless content to surprise and drive away the living body 600. When the harmless content is used, it is highly safe in a case of the accidental shooting.

FIG. 8B shows an example of a procedure of shooting the content to the living body 600. FIG. 8B shows a situation which occurs after the example shown in FIG. 8A, and in which the living body 600 is accustomed to being shot by the content 101, and thus cannot be driven away. In this way, the living body 600 may learn that the content 101 is harmless. In this case, the selection unit 37 may select the content having higher repelling ability.

FIG. 8C shows an example of a procedure of shooting the content to the living body 600. FIG. 8C shows a situation which occurs after the example shown in FIG. 8B, and in which another content is selected to drive away the living body 600. The living body 600 of the present example has learned that the content 101 is harmless; however, a content 103, which is more irritating than the content 101, is shot and the living body 600 escapes.

By shooting the safe content 101 at first, the unmanned aerial vehicle 100 of the present example can avoid damage due to the accidental shooting. On the other hand, when the living body 600 learns and an effect of the content 101 disappears, it is possible to select and shoot the different content 103. This makes it possible for the unmanned aerial vehicle 100 to realize safe and effective shooting.

In addition, the unmanned aerial vehicle 100 may shoot the content having an attracting ability to lure the living body 600, and then shoot the marking material or the content having a repelling ability. Luring the living body 600 enhances a rate of hitting the living body 600.

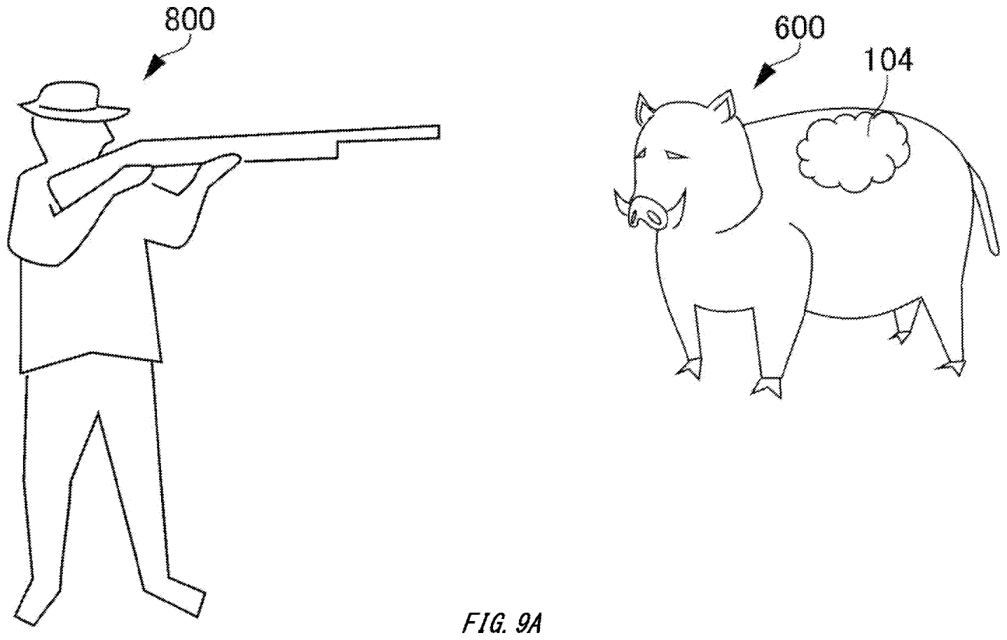

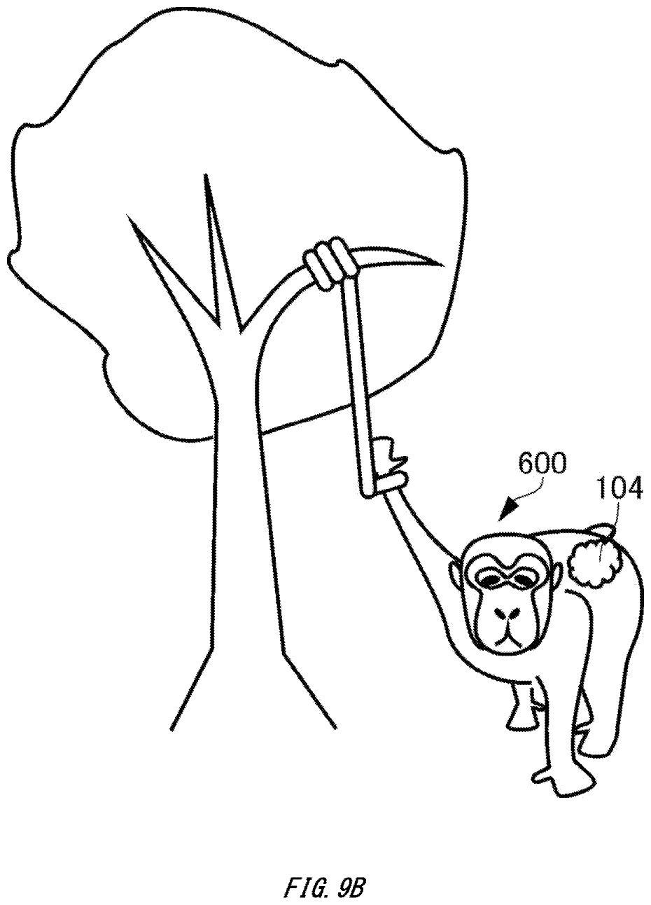

FIG. 9A is an example of a method of utilizing a marking material 104. In the present example, the marking material 104 is shot to the living body 600 that is a hunting target.

The marking material 104 is, in an example, fluorescent paint for coloring the living body 600. The marking material 104 may be a material for following a track of the living body 600, or may be a material for following an odor. For example, when the living body 600 is colored by the marking material 104, it is possible for a hunter 800 to easily find the living body 600 even at night. In the present example, the marking material 104 adheres to the trunk of the living body 600.

FIG. 9B is an example of a method of utilizing the marking material 104. In the present example, by marking the living body 600, it is possible to identify the captured living body 600 with shooting data in the past, and authenticate the individual living body 600 that is captured. For example, the unmanned aerial vehicle 100 stores contents such as the content marked on the living body 600, the shooting region, or the shooting time. After the living body 600 is captured, by searching for the marking material 104 applied to the living body 600 in the database, it is possible to acquire information of the living body 600 such as ecology and a frequently appearing location.

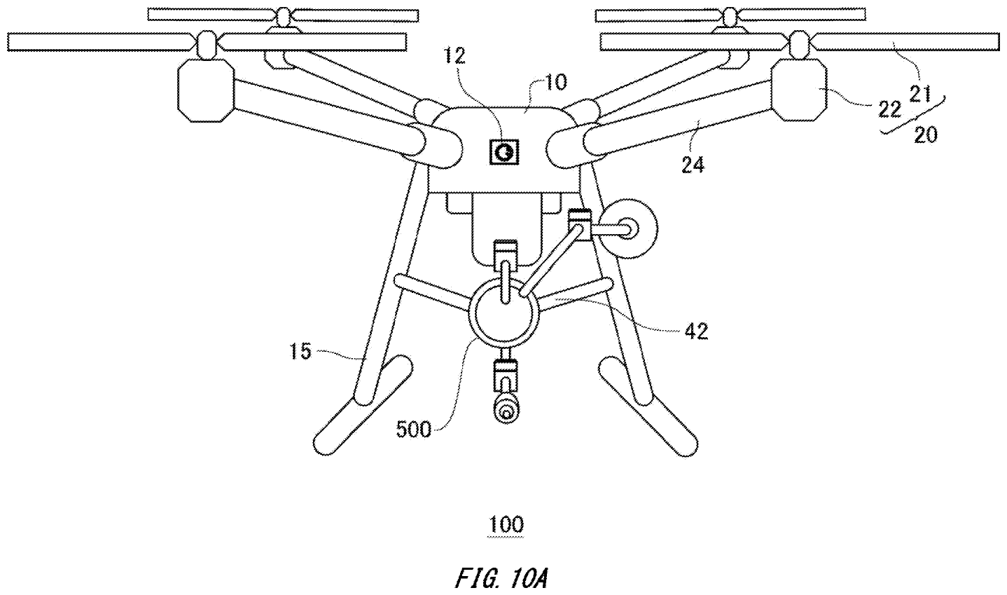

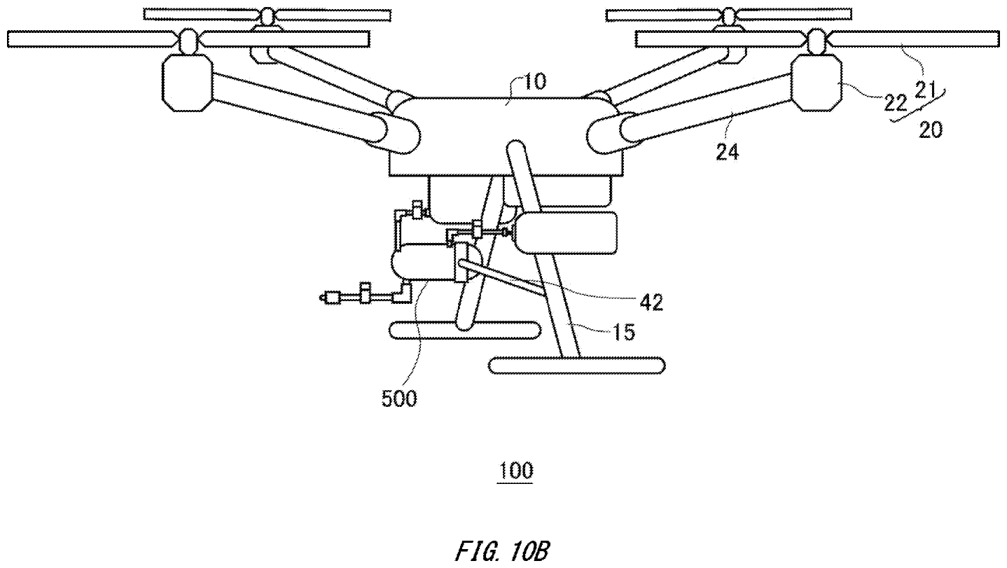

FIG. 10A shows an example of the front view of the unmanned aerial vehicle 100. FIG. 10B shows an example of a left side view of the unmanned aerial vehicle 100 according to FIG. 10A. The unmanned aerial vehicle 100 of the present example includes a support frame 42 and a shooting device 500.

The support frame 42 connects the main body unit 10 and the shooting device 500. The support frame 42 may be fixed, or may be movable. The support frame 42 may be a gimbal for controlling a position of the shooting device 500 in the three axis directions. In an example, the support frame 42 adjusts a shooting direction of the shooting device 500 by moving the position of the shooting device 500. As shown in FIG. 10A and FIG. 10B, the support frame 42 may connect a holding container 510 (described below) of the shooting device 500, and the leg unit 15, but may connect another portion of the shooting device 500, and another portion of the unmanned aerial vehicle 100. In addition to the holding container 510 of the shooting device 500 being connected to the leg unit 15 of the unmanned aerial vehicle 100 by the support frame 42 as shown in FIG. 1A and FIG. 1B, a pressurization unit 520 (described below) of the shooting device 500 may also be directly attached to the leg unit 15. In addition, the shooting direction of the shooting device 500 may be adjusted by fixing the support frame 42 and setting the shooting unit 50 of the shooting device 500 to be movable.

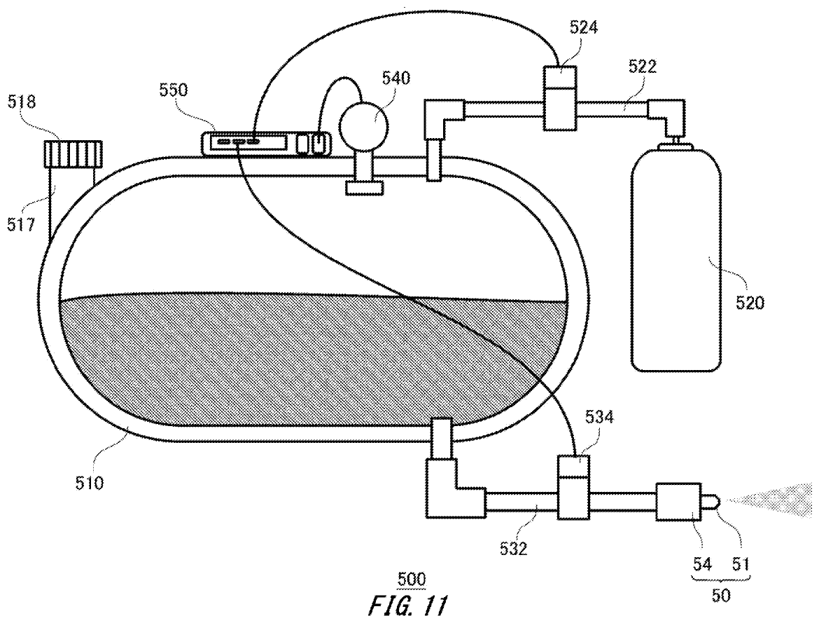

FIG. 11 shows an example of a shooting device 500 in the unmanned aerial vehicle 100.

The shooting device 500 includes the shooting unit 50, the holding container 510, the pressurization unit 520, an internal pressure sense unit 540, and a control unit 550. The holding container 510 is connected to the pressurization unit 520 by a first connection unit 522, and is connected to the shooting unit 50 by a second connection unit 532. The first connection unit 522 has a first switch unit 524 between the holding container 510 and the pressurization unit 520, and the second connection unit 532 has a second switch unit 534 between the holding container 510 and the shooting unit 50. The first switch unit 524 and the second switch unit 534 are, for example, electromagnetic valves. The first switch unit 524, the second switch unit 534, and the internal pressure sense unit 540 are electrically connected to the control unit 550 via a control line such as a conducting wire.

The holding container 510 holds the content to be shot from the shooting device 500. The holding container 510 is an example of a pressurized tank. The holding container 510 is made of a composite material, for example, such as metal or fiber reinforced plastic, and has pressure resistance with which damage due to pressure by the pressurization unit 520 does not occur. The holding container 510 has a holding container inlet 517 for replenishing the content, and a holding container cap 518 for closing the holding container inlet 517.

The pressurization unit 520 sprays a filling material to an inside of the holding container 510 by the aerosol container, and pressurizes the holding container 510. The pressurization unit 520 may be driven by a principle similar to that of the container holding unit 40 shown in FIG. 3.

The filling material sprayed by the pressurization unit 520 is supplied to the inside of the holding container 510 through the first connection unit 522, and pressurizes the holding container 510. By this pressure, the content of the holding container 510 is pushed out through the second connection unit 532, and is shot from the shooting unit 50 to an outside.

The first switch unit 524 opens and closes in response to an electrical signal from the control unit 550, and thus switches between causing and not causing the holding container 510 and the pressurization unit 520 to communicate with each other.

Similarly, the second switch unit 534 opens and closes in response to an electrical signal from the control unit 550, and thus switches between causing and not causing the holding container 510 and the shooting unit 50 to communicate with each other.

The internal pressure sense unit 540 senses internal pressure of the holding container 510 and outputs the sensed internal pressure of the holding container 510 to the control unit 550.

The control unit 550 may control an operation of the first switch unit 524 according to a sense result of the internal pressure sense unit 540. For example, when a remaining amount of the content of the holding container 510 decreases and the internal pressure of the holding container 510 falls below a predetermined lower limit threshold value, the control unit 550 may open the first switch unit 524, and cause the holding container 510 and the pressurization unit 520 to communicate with each other to perform the pressurization by the pressurization unit 520. Note that here, the operation of the pressurization unit 520 spraying the filling material to pressurize the holding container 510 may be performed before the first switch unit 524 is opened, or may be performed after the first switch unit 524 is opened. Then, when the internal pressure of the holding container 510 exceeds a predetermined upper limit threshold value due to the pressure by the pressurization unit 520, the control unit 550 may close the first switch unit 524, and stop the pressurization by the pressurization unit 520.

When it is necessary to shoot the content of the holding container 510 from the shooting unit 50, the control unit 550 may open the second switch unit 534, and cause the holding container 510 and the shooting unit 50 to communicate with each other to shoot the content from the shooting unit 50. At this time, when the internal pressure of the holding container 510 is sufficiently high, the content of the holding container 510 is shot from the shooting unit 50.

A connection location between the holding container 510 and the first connection unit 522 may be provided on a side above a connection location between the holding container 510 and the second connection unit 532. In the example shown in FIG. 11, the first connection unit 522 is provided on an upper surface of the holding container 510. This makes it possible to prevent the first connection unit 522 from touching the content of the holding container 510 and the first connection unit 522 from being contaminated by the content.

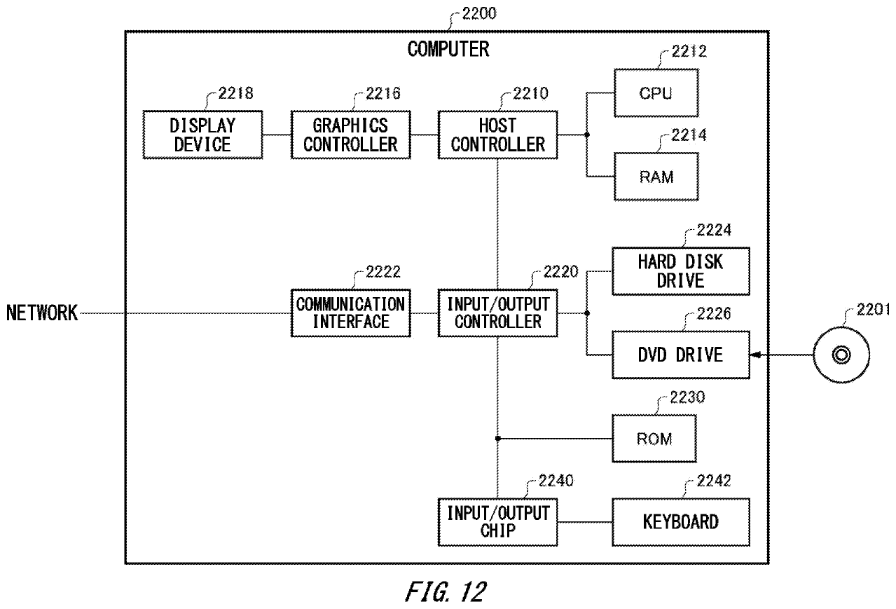

FIG. 12 shows an example of a computer 2200 in which a plurality of aspects of the present invention may be embodied entirely or partially. A program that is installed in the computer 2200 can cause the computer 2200 to function as operations associated with apparatuses according to the embodiments of the present invention or one or more sections of the apparatuses, or can cause the computer 2200 to execute the operations or the one or more sections thereof, and/or can cause the computer 2200 to execute processes according to the embodiments of the present invention or steps of the processes. Such a program may be executed by a CPU 2212 to cause the computer 2200 to execute certain operations associated with some or all of the blocks of flowcharts and block diagrams described herein.

The computer 2200 according to the present embodiment includes the CPU 2212, a RAM 2214, a graphics controller 2216, and a display device 2218, which are interconnected by a host controller 2210. The computer 2200 also includes input/output units such as a communication interface 2222, a hard disk drive 2224, a DVD-ROM drive 2226, and an IC card drive, which are connected to the host controller 2210 via an input/output controller 2220. The computer also includes legacy input/output units such as a ROM 2230 and a keyboard 2242, which are connected to the input/output controller 2220 via an input/output chip 2240.

The CPU 2212 operates according to programs stored in the ROM 2230 and the RAM 2214, thereby controlling each unit. The graphics controller 2216 obtains image data generated by the CPU 2212 on a frame buffer or the like provided in the RAM 2214 or in itself, and causes the image data to be displayed on the display device 2218.

The communication interface 2222 communicates with other electronic devices via a network. The hard disk drive 2224 stores programs and data used by the CPU 2212 within the computer 2200. The DVD-ROM drive 2226 reads the programs or the data from a DVD-ROM 2201, and provides the hard disk drive 2224 with the programs or the data via the RAM 2214. The IC card drive reads the program and data from an IC card, and/or writes the program and data to the IC card.

The ROM 2230 stores, in itself, a boot program or the like that is executed by the computer 2200 during activation, and/or a program that depends on hardware of the computer 2200. The input/output chip 2240 may also connect various input/output units to the input/output controller 2220 via a parallel port, a serial port, a keyboard port, a mouse port, and the like.

A program is provided by a computer-readable medium such as the DVD-ROM 2201 or the IC card. The program is read from the computer-readable medium, installed in the hard disk drive 2224, the RAM 2214, or the ROM 2230, which is also an example of the computer-readable medium, and executed by the CPU 2212. The information processing written in these programs is read into the computer 2200, resulting in cooperation between a program and the above-mentioned various types of hardware resources. An apparatus or method may be constituted by realizing the operation or processing of information in accordance with the usage of the computer 2200.

For example, when a communication is executed between the computer 2200 and an external device, the CPU 2212 may execute a communication program loaded in the RAM 2214, and instruct the communication interface 2222 to process the communication based on the processing written in the communication program. The communication interface 2222, under control of the CPU 2212, reads transmission data stored on a transmission buffering region provided in a recording medium such as the RAM 2214, the hard disk drive 2224, the DVD-ROM 2201, or the IC card, and transmits the read transmission data to a network or writes reception data received from a network to a reception buffering region or the like provided on the recording medium.

In addition, the CPU 2212 may cause all or a necessary portion of a file or a database to be read into the RAM 2214, the file or the database having been stored in an external recording medium such as the hard disk drive 2224, the DVD-ROM drive 2226 (the DVD-ROM 2201), the IC card, etc., and execute various types of processing on the data on the RAM 2214. The CPU 2212 then writes back the processed data to the external recording medium.

Various types of information, such as various types of programs, data, tables, and databases, may be stored in the recording medium to undergo information processing. The CPU 2212 may execute various types of processing on the data read from the RAM 2214 to write back a result to the RAM 2214, the processing being described throughout the present disclosure, specified by instruction sequences of the programs, and including various types of operations, information processing, condition determinations, conditional branching, unconditional branching, information retrievals/replacements, or the like. In addition, the CPU 2212 may search for information in a file, a database, etc., in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-described program or software modules may be stored in the computer-readable media on the computer 2200 or near the computer 2200. In addition, a recording medium such as a hard disk or a RAM provided in a server system connected to a dedicated communication network or the Internet can be used as a computer-readable medium, thereby providing the program to the computer 2200 via the network.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 . . . main body unit, 12 . . . fixed camera, 15 . . . leg unit, 20 . . . propulsion unit, 21 . . . rotor blade, 22 . . . rotation drive unit, 24 . . . arm unit, 30 . . . movable camera, 32 . . . connection unit, 35 . . . detection unit, 37 . . . selection unit, 40 . . . container holding unit, 41 . . . main body, 42 . . . support frame, 43 . . . first end cover unit, 44 . . . second end cover unit, 45 . . . screw unit, 50 . . . shooting unit, 51 . . . shooting port, 52 . . . direction change device, 53 . . . extension unit, 54 . . . nozzle, 60 . . . aiming unit, 70 . . . impact control unit, 80 . . . shooting drive unit, 81 . . . cam, 82 . . . cam follower, 83 . . . movable plate, 90 . . . determination unit, 95 . . . storage unit, 100 . . . unmanned aerial vehicle, 101 . . . content, 103 . . . content, 104 . . . marking material, 143 . . . actuator , 145 . . . stem, 150 . . . container, 200 . . . terminal device, 210 . . . display unit, 212 . . . center location, 214 . . . display screen, 216 . . . display screen, 220 . . . controller, 230 . . . controller, 231 . . . control stick, 232 . . . antenna, 233 . . . power button, 234 . . . return button, 235 . . . takeoff button, 236 . . . camera operation stick, 240 . . . controller, 241 . . . first shooting button, 242 . . . second shooting button, 243 . . . third shooting button, 244 . . . selection dial, 245 . . . shooting button, 250 . . . controller, 300 . . . steering system, 500 . . . shooting device, 510 . . . holding container, 517 . . . holding container inlet, 518 . . . holding container cap, 520 . . . pressurization unit, 522 . . . first connection unit, 524 . . . first switch unit, 532 . . . second connection unit, 534 . . . second switch unit, 540 . . . internal pressure sense unit, 550 . . . control unit, 600 . . . living body, 700 . . . flying object, 800 . . . hunter, 2200 . . . computer, 2201 . . . ROM, 2210 . . . host controller, 2212 . . . CPU, 2214 . . . RAM, 2216 . . . graphics controller, 2218 . . . display device, 2220 . . . output controller, 2222 . . . communication interface, 2224 . . . hard disk drive, 2226 . . . ROM drive, 2230 . . . ROM, 2240 . . . output chip, 2242 . . . keyboard

1. An unmanned aerial vehicle comprising:
a detection unit configured to detect a living body;
an aiming unit configured to aim at a specific part of the living body based on a detection result of the living body; and
a shooting unit configured to shoot a content, which is stored in a container, to the specific part.

2. The unmanned aerial vehicle according to claim 1, comprising:
a storage unit configured to store data relating to the living body and the content; and
a determination unit configured to determine whether it is possible to shoot the content based on the stored data.

3. The unmanned aerial vehicle according to claim 1, comprising:
an impact control unit configured to match an expected impact location of the shooting unit to the specific part.

4. The unmanned aerial vehicle according to claim 3, comprising:
a direction change device that is connected to the shooting unit, wherein
the impact control unit is configured to control the direction change device to match the expected impact location of the shooting unit to the specific part.

5. The unmanned aerial vehicle according to claim 3, comprising:
a nozzle that is provided in the shooting unit and that is configured to shoot the content; and
a direction change device that is connected to the nozzle, wherein
the impact control unit is configured to control the direction change device to match the expected impact location of the shooting unit to the specific part.

6. The unmanned aerial vehicle according to claim 1, comprising:
a first camera for detecting the living body; and
a second camera for operating the unmanned aerial vehicle.

7. The unmanned aerial vehicle according to claim 1, comprising:
a plurality of containers in which different contents are respectively stored; and
a selection unit configured to select the content to be used according to the detection result of the living body, and select the container for shooting the content.

8. The unmanned aerial vehicle according to claim 7, wherein
the selection unit is configured to switch the content to be shot to the living body according to a reaction of the living body to the shot content.

9. The unmanned aerial vehicle according to claim 8, wherein
the content has a repelling ability against the living body.

10. The unmanned aerial vehicle according to claim 8, wherein
the content has an attracting ability to the living body.

11. The unmanned aerial vehicle according to claim 7, wherein
the selection unit is configured to switch the content to enhance a performance, in switching the content to be shot to the living body.

12. The unmanned aerial vehicle according to claim 1, wherein
the content is a marking material for marking the living body.

13. The unmanned aerial vehicle according to claim 1, wherein
the shooting unit is connected to at least one of an aerosol container or a pressurized tank.

14. A shooting method for shooting a content by using an unmanned aerial vehicle, the method comprising:
detecting a living body;
aiming at a specific part of the living body based on a detection result of the living body; and
shooting a content, which is stored in a container, to the specific part.

15. The shooting method according to claim 14, comprising:
storing data relating to the living body and the content; and
determining whether it is possible to shoot the content based on the stored data.

16. The shooting method according to claim 14, comprising:
matching an expected impact location of the content to the specific part.

17. The shooting method according to claim 14, comprising:
selecting the content in accordance with the detection result of the living body, from among a plurality of contents.

18. The shooting method according to claim 17, wherein
the selecting includes switching the content to be shot to the living body according to a reaction of the living body to the shot content.

19. The shooting method according to claim 17, wherein
the selecting includes switching the content to enhance a performance, in switching the content to be shot to the living body.

20. A non-transitory computer-readable storage medium having a program recorded thereon, wherein the program, when executed by a computer, causes the computer to execute:
detecting a living body;
aiming at a specific part of the living body based on a detection result of the living body; and
shooting a content, which is stored in a container, to the specific part.
